(19) United States
(12) Patent Application Publication
(10) Pub. No.: US 2008/0263067 A1
(43) Pub. Date: Oct. 23, 2008

(54) Method and System for Entering and Retrieving Content from an Electronic Diary

(75) Inventors: Elmo Marcus Attila Diederiks, Eindhoven (NL); Henriette Christine Marie Hoonhout, Eindhoven (NL); Albertus Josephus Nicolaas Breemen, Lommel (BE); Peter Bingley, Mierlo (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,827

(22) PCT Filed: Oct. 24, 2006
(86) PCT No.: PCT/IB06/53916

§ 371 Date: Apr. 28, 2008

Related U.S. Application Data
(60) Provisional application No. 60/730,662, filed on Oct. 27, 2005.

(51) Int. Cl. G06F 17/30; G10L 15/26; G06K 9/00

(52) U.S. Cl. 707/100; 704/235; 382/100

(57) ABSTRACT

An electronic diary that receives diary annotations, derives metadata from the diary annotations, and stores the diary annotations and the derived metadata. The electronic diary may provide user feedback in response to receiving the diary annotations. The electronic diary may render a previously stored diary annotation based on a correlation with the received diary annotation.

The present invention relates to a system, and a method for enabling people to add information to a personal diary via voice and an integrated video camera. The system and method further enables people to retrieve the information using voice or by connecting the system to a viewing apparatus.

For hundreds of years people from all walks of life have kept dairies. Writing about stressful events has long been known to cause improvements in health and psychological well-being. Recent research indicates that expressive writing reduces intrusive and avoidant thoughts about negative events and improves working memory.

These improvements, researchers believe, may in turn free up our cognitive resources for other mental activities, including our ability to cope more effectively with stress. Throughout history, diaries have generally been hand-written in a bound notebook on consecutive pages on which the date is either pre-recorded or is entered by the diarist as the entries are made. One drawback associated with this traditional method of keeping a diary is the inability to retrieve particular content such as, for example, what was said about a particular person on a particular day. The diarist cannot easily go back and find what was written and when. A further drawback associated with traditional dairying methods is that only a proportionally small amount of text can be inserted at a later date, and this can possibly be detected by changes in ink or slight changes in handwriting, or by the fact that the additions have been written in the margin.

More recently, electronic diaries have been introduced which overcome some of the afore-mentioned drawbacks associated with traditional diaries. An electronic diary that offers the look and feel of a paper diary, such as the Star Message Diary™ software from Regnow/Digital River of Eden Prairie, Minn. is known. The electronic diary provides particular advantages over traditional diaries including, for example, high security and password protection, separate diaries for each member of the family, export capability to RTF, an unlimited number of diary entries anywhere from the year 1900 to 2100, and user selectable fonts, colors, sizes, and styles for text and graphics.

One drawback associated with such electronic diaries, however, is that diary data must be input into a personal computer or mobile device using a keyboard incorporated into the device or using electronic pen entry. This can be time consuming and prone to error.

It is therefore an object of the present system to provide a way to make and retrieve diary annotations which overcomes these and/or other limitations of the prior art.

In a first aspect, the invention provides an electronic diary including diary function means for adding diary annotations via a combination of voice and video input. The diary function means further comprises means for retrieving diary annotations using a combination of voice and video.

In a second aspect, the electronic diary preferably stores all annotations with additional metadata, such as date and time. The metadata may be derived in real-time as the annotation is added to the electronic diary.

In another aspect, the user and/or the electronic diary may initiate the process of content retrieval. A user can explicitly ask the electronic diary to either display or playback a previously stored diary annotation. In an embodiment, the electronic diary may suggest to retrieve previously stored diary annotations whenever the electronic diary detects similar subject matter being entered into the diary, such as by voice.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details would still be understood to be within the scope of the appended claims. Moreover, for the purpose of clarity, detailed descriptions of well-known devices, circuits, and methods are omitted so as not to obscure the description of the present invention.

It should be expressly understood that the drawings are included for illustrative purposes and do not represent the scope of the present invention.

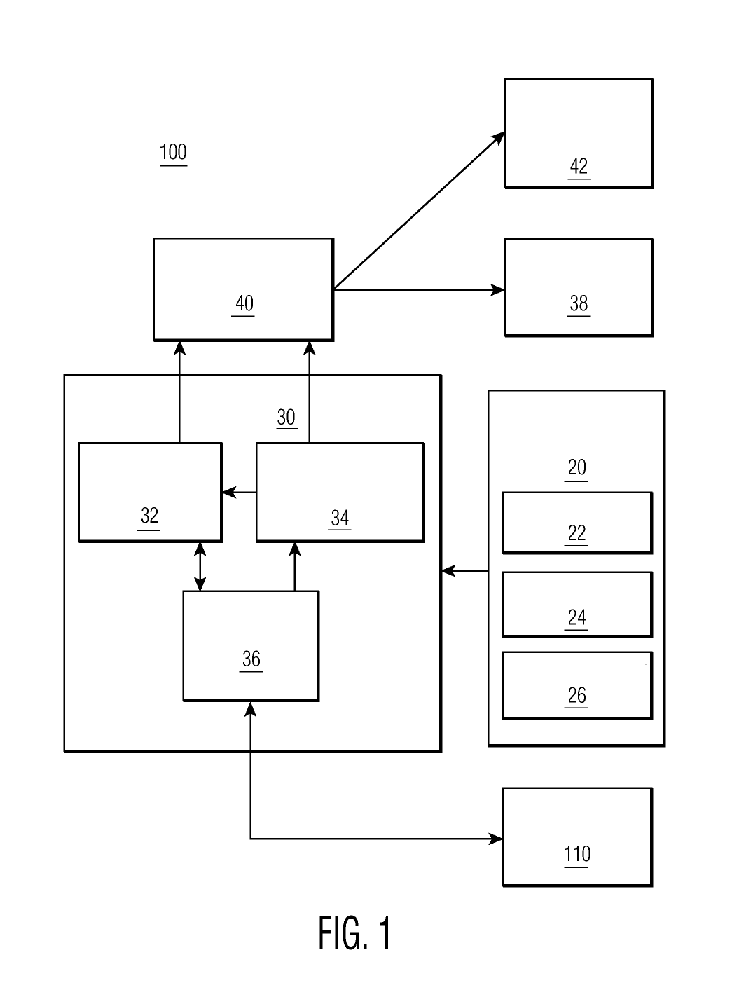

FIG. 1 is an illustrative block diagram of the elements that comprise the electronic diary, according to an embodiment of the present system;

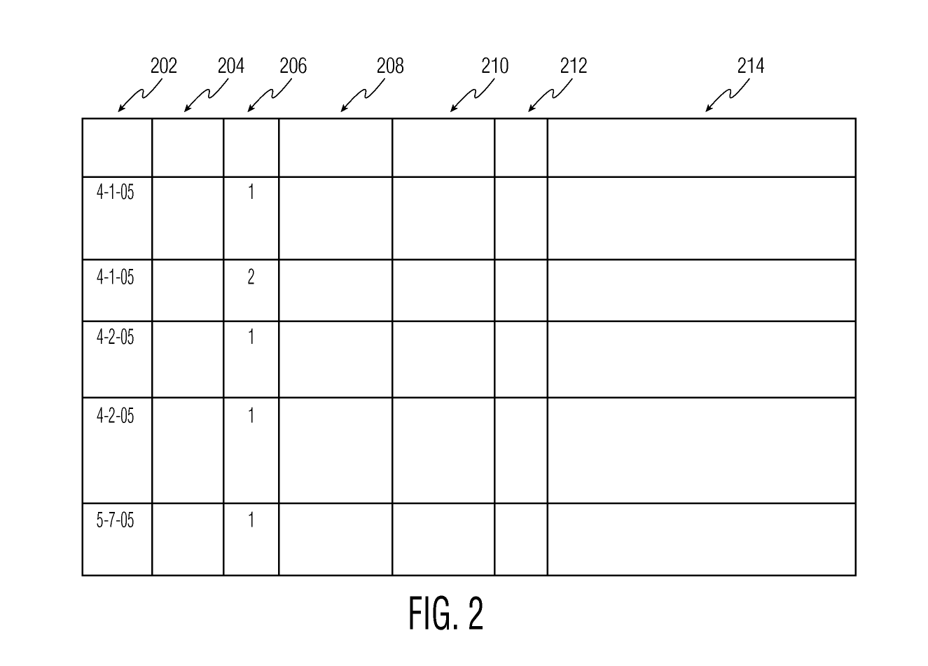

FIG. 2 is an illustrative table representing the storage module of the electronic diary, according to an embodiment of the present system;

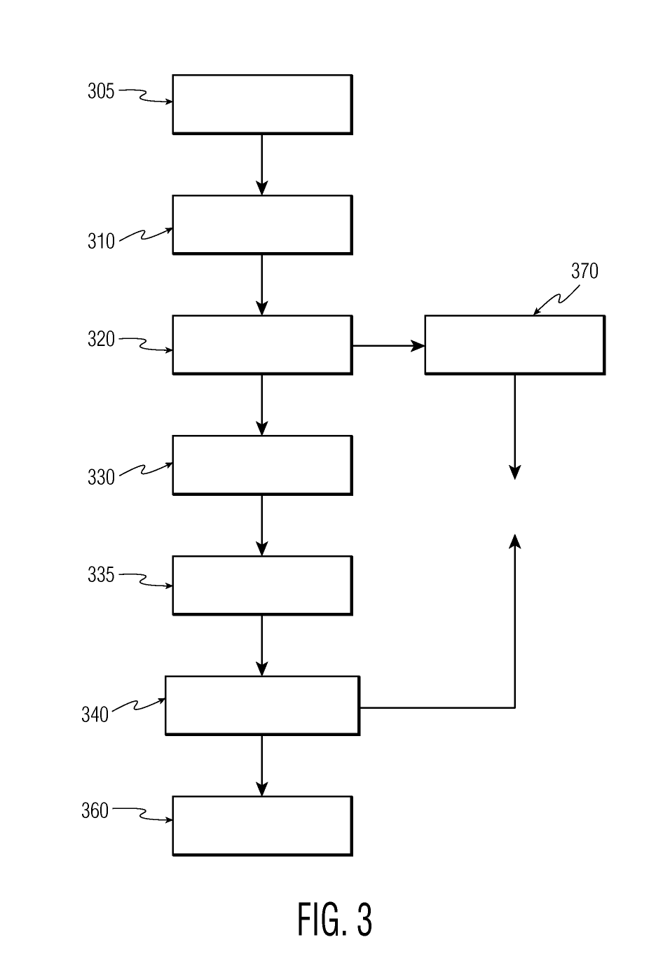

FIG. 3 is a flow diagram representing an illustrative storage operation of an annotation in accordance with an embodiment of the present system; and

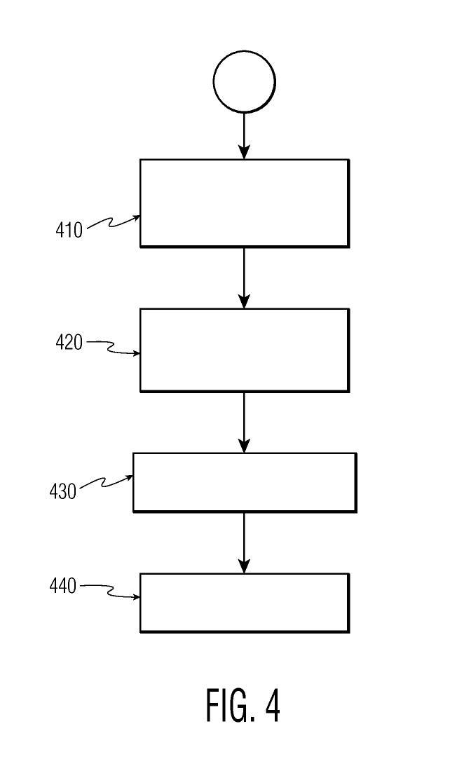

FIG. 4 is a flow diagram representing an illustrative retrieval operation of an annotation in accordance with an embodiment of the present system.

Although the following description contains many specifics for the purpose of illustration, one of ordinary skill in the art will appreciate that many variations and alterations to the following description are within the scope of the system as claimed. The present system and method will be described below with reference to an illustrative system. For example, the present system is described with regard to particular types of input/output annotations to/from the diary, such as video and voice annotations. Clearly the present diary is applicable to many annotation types including, without limitation, video annotations, audio annotations, image/video annotations, text annotations, and combinations thereof. For illustrative purposes and to simplify the following discussion, the present system will be described below with regard to video and voice annotations. In addition, each type of annotation has ways in which a user enters and observes it. For example, audio/visual annotations may be provided to the user in the form of an audible and/or visual signal. Textual annotations may be provided as a visual signal. For the sake of brevity, the discussion that follows discusses particular ways in which annotations are entered and retrieved but is intended to encompass other ways in which annotations may be suitably entered and retrieved by the user based on the type of annotation and/or based on preferences of the user. The present system is applicable to numerous alternate embodiments that would readily occur to a person of ordinary skill in the art. The alternate systems are encompassed by the appended claims. Accordingly, the following embodiments are set forth without any loss of generality to, and without imposing limitations upon, the claimed invention.

The present invention may be an individual diary associated with a user of the device. This may be the case when the device that implements the diary is personal in nature, such as a PDA or the like. However, the diary may also provide for a multiple-user environment in which the diary is set-up such that multiple users may access the diary, with access controlled, for example, by individual user identification and passwords. A diary in accordance with an embodiment may be a family diary that is implemented on a home computer or on a server in a network environment with each member of the family having individual access.

Typical operations performed by the diary 100 of the present invention may include, for example, receiving diary annotations from users, storing the received diary annotations and retrieving previously stored diary annotations responsive to user requests for the previously stored diary annotations. In addition, the diary 100 may suggest previously stored annotations in response to user interaction with the diary 100 independent of a user's particular request to retrieve annotations. These and other operations are discussed in greater detail as follows.

The following discussion of operation of the present diary is illustratively in terms of functional modules of the diary 100. As would be readily apparent, several of these modules may be implemented as a portion of a computer program operated on by a processor. A processor may be a dedicated processor for operation in accordance with the present diary, or it may be a general purpose processor that operates in accordance with the present diary as only one of a plurality of other operations. The processor may also be a dedicated integrated circuit that is configured for operation in accordance with the present diary. The modules as discussed herein should be understood to encompass these and other implementations including other devices that may support a module's functionality.

Operation of the present system will be described herein with reference to FIGS. 1 and 3.

As illustratively shown in FIG. 1, the diary 100 includes an input module 20, a content management module 30, a dialogue management module 40, a speech synthesis module 38, and a renderer for non-verbal communications (RNVC) 42.

The voice and video diary device 100 operates by receiving diary inputs during act 310 through the input module 20 that includes a voice recognition module 22, a video/image capture module 24 and a touch/sensory input module 26.

Voice inputs are processed in the voice recognition module 22 of the input module 20 and image inputs, such as video inputs are processed in the video/image capture module 24. Other types of inputs, such as typed, stylus, etc. may be processed through the touch/sensory input module 26. The inputs to the diary 100 are supplied to the content management module 30. Numerous types of other inputs/outputs would occur to a person of ordinary skill in the art and each of these types of inputs/outputs may be readily utilized by the present system. While much of the discussion to follow is illustratively discussed with regard to video and voice inputs/outputs, it is apparent that the other types of inputs/outputs would operate similarly. Each of these other inputs/outputs should be understood to be within the scope of the appended claims.

As shown in FIG. 1, the content management module 30 is comprised of three modules, a content retrieval management (CRM) module 32, a content understanding and metadata generation (CUMG) module 34, and a storage module 36.

The CUMG module 34 receives input from the input module 20 and analyzes the input during act 320 to determine what type of input is being provided. For example and without limitation, input may be in the form of a user request for retrieval of a previously stored annotation as indicated during act 370. Input may also be in the form of an annotation that the user wishes the diary 100 to store as indicated during act 330. The CUMG module 34 may also analyze the received input to facilitate annotation storage and retrieval. The CUMG module 34 may determine and associate metadata with input to aid in management, identification, storage and retrieval. Metadata is determined and associated with input including annotations during act 340 which is illustratively shown after the input is determined to be an annotation (e.g., see acts 320 and 330). The metadata may include descriptive information about the input or attributes of the input, such as a name of an input file, a length of the input (e.g., number of bytes), a data type of the input (e.g., visual or auditory), etc. Metadata may be already associated with an input, such as a portion of an annotation that is provided from a remote storage device (e.g., an attached photograph). Metadata may also be associated by devices that captured/created the input, such as a digital camera (e.g., video image capture module 24) that creates metadata for images captured by the camera, such as camera setting, time of photograph, etc. Metadata may be associated with input by a user of the diary 100.

In this way, metadata may consist of a combination of derived metadata (obtained in real-time from the processed input) and non-derived data as above including a date and time of input entry. For example, a video/image input may be analyzed to identify features of the input, such as faces, buildings, monuments and other objects depicted within the input using feature extraction techniques. Voice related metadata may be derived by identifying phrases of the processed voice inputs. Other types of input may be similarly analyzed to determine associated metadata.

The metadata including video and voice metadata along with the respective processed input may be stored in the storage module 36 for later retrieval during act 360, for example if the CUMG module 34 determines that the input type is an annotation for storage. As used herein, an annotation may be any form that is received by the diary 100, including video and/or voice diary annotations and any associated metadata (derived and non-derived).

Stored annotations may be retrieved from the storage module 36, in response to a user request as a result of the determination during act 320 and/or may otherwise be retrieved independent of a user request (see act 340). In certain embodiments, when the user makes an annotation in the diary 100, the diary 100 may analyze metadata derived from the annotation during act 410 (see, FIG. 4) and suggest stored annotations to the user during act 430 that has some degree of correlation (act 420) with the current annotation being made. Retrieved annotations may be presented to the user during act 440, such as by being displayed on a rendering device 110, like a television or personal display. For example, stored auditory annotations, such as voice annotations may be retrieved from the storage module 36, either in response to a user request or may otherwise be retrieved and be provided to the user by the system independent of a user request. The retrieved auditory annotation may then be rendered to the user by the speech synthesis module 38.

The use by a user of the diary 100, such as storage and retrieval of annotations, is supported through a suitable user interface. The user interface includes at least one of textual, graphical, audio, video, autonomic, and animation elements. The user may interact with the user interface, and thereby the diary 100 using any suitable input device. For example and without limitation, the user may interact with the diary 100 through the use of a computer mouse, a computer keyboard, a remote control device, a general purpose or dedicated stylus device, an input button, a joystick, a jog-dial, a touch pad, a navigation button, and/or even a finger or other probe of a user. As an illustration without limitation, the user is presented the user interface though one or more of the RNVC 42 and the speech synthesis module 38 and interacts with the user interface through the input module 20. Of course, any of a plurality of the modules displayed in FIG. 1 may in fact be comprised of a single module for both input and output operation. For example, a display device (e.g., RNVC 42) may have a display surface that operates to display an output, such as a current or previously entered annotation, to a user. The display device may also be touch-sensitive so that it may also support receiving input from the user. Each of these operations would be supported through the use of the suitable user interface.

A feature of the present invention is the manner in which a user may enter and/or retrieve diary annotations. Specifically, the diary 100 may receive/retrieve diary annotations in any format, including video and voice. Illustratively, video and voice annotations are each more fully described as follows.

To make a voice annotation, various initialization operations are contemplated during act 305 for a user to indicate to the diary 100 that an annotation is intended to follow generally (e.g., any type of annotation), or the initialization may indicate a type of annotation (e.g., a voice annotation) to follow. The initialization operations may include, for example, a user depression of a button, such as a start annotation button; a voiced keyword trigger, such as a user stating “start voice annotation”. The diary 100 may even receive input that is both a voiced keyword trigger and a part of the annotation, such as the user using the phrase “Dear Diary . . . ” In this case, the CUMG module may receive the input (e.g., “Dear Diary”) and interpret it as a voiced keyword trigger as well as a beginning of an annotation for storage.

Of course any other way that a user may initiate input to the diary 100 is contemplated by the present system. When the user initiates a voice annotation in the manner described above or by other means, the diary 100 may provide some form of feedback during act 335 to indicate that input of a voice annotation has been initiated. This feedback may include, for example: an LED, a verbal feedback cue (e.g., “I am listening . . . ”), and/or an emotive response in the case of a robotic embodiment (e.g., nodding or smiling).

In the case of a robotic embodiment, the RNVC module 42 receives input from the dialogue management module 40 indicating a user's desire to initiate a voice annotation.

The RNVC module 42 may include a number of pre-programmed non-verbal responses such as, for example, a wink, raised eyebrows, and/or a hand gesture (e.g., an “OK” gesture) to indicate to the user that a voice annotation is initiated.

To enable use of voice input to the diary 100, such as enabling a user to make a diary voice annotation (diary entry by voice) or otherwise satisfy a user auditory request to retrieve a previously stored diary annotation (e.g., video and/or voice), the diary 100 may include a voice recognition interface module 22 for processing user auditory inputs to the diary 100. Subsequent to being processed by the voice recognition interface module 22, the recognized voice inputs are provided to the CUMG module 34 which determines metadata for the recognized voice inputs. Naturally, voice recognition may be performed directly on voice input by the CUMG module 34, in which case the input module 20 may only have an auditory capture device, such as a microphone.

For example, the CUMG module 34 may determine the metadata from voice inputs in numerous ways including applying grammar rules to extract topical information associated with the recognized user voice inputs. The following sentences (left hand column) are representative of an illustrative recognized voice input. The application of grammar rules is shown on the right.

| Sentence | Grammar Rule |
|---|---|
| “Mark is a really cute guy” | Mark is the subject |
| “I think he likes me” | Mark is the subject, since “I” |
| | and “me” refer to the user of |
| | the device itself, and “he” |
| | refers to Mark in the previous |
| | sentence. |
| “At least I like him very much” | Again Mark is the subject |

In accordance with the operation of the CUMG module 34, metadata may be derived (determined) from the application of grammar rules (right hand side) to the processed voice inputs (i.e., the sentences). The derived metadata (e.g., “SUBJECT=MARK”) may be derived in real time and may be stored in association with the processed user voice inputs in the storage module 36. Non-derived forms of metadata, such as date and time, may also be stored along with the derived metadata and processed user voice inputs in the storage module 36. In general, the metadata provides an index to stored annotations, such as user voice inputs, to facilitate retrieval and access by the user.

The present invention contemplates other techniques to ascertain the metadata associated with annotations. For example, imaging techniques may be utilized to identify location features associated with image annotations. The identified location features may be utilized as derived metadata. U.S. patent application Ser. No. 10/295,668, filed Nov. 15, 2002 and entitled “Content Retrieval Based On Semantic Association”, to Dongge Li et al., which is incorporated herein by reference as if set out in entirety, discloses methods for analyzing multimedia content for identifiable objects and indexing and retrieving multimedia content from different modalities (e.g., text, image, acoustic). U.S. Pat. No. 6,243,713, issued Jun. 5, 2001 and entitled “Multimedia Document Retrieval by Application of Multimedia Queries to a Unified Index of Multimedia Data For a Plurality of Multimedia Data Types”, to Nelson et al., which is incorporated herein by reference as if set out in entirety, discloses systems and methods for multimedia document retrieval by indexing compound documents, including multimedia components such as text, images, audio, or video components into a unified common index to facilitate document retrieval.

In any case and regardless of how the metadata is derived, the processed voice inputs and the associated metadata are stored in the storage module 36 during act 360 for later retrieval as described above.

Referring to FIG. 2, entries to a table represent annotations and associated metadata stored to the storage module 36 of the diary 100, according to an embodiment of the present invention. The table also includes fields 202, 204, 206, 208, 210, 212 and 214 for each of the annotations. The fields specify: a diary date of entry 202, a diary time of entry 204, a user identifier 206, a diary annotation identifier 208, an annotation file name 210, a file type 212 and other metadata 214.

The diary date of entry field 202, time of entry 204, the user ID 206, type of file field 210, and elements of field 214 such as privacy setting (e.g., PRIVACY=1), image acquisition settings (e.g., SETTINGS=S500 F2.8), etc. may collectively comprise non-derived meta-data. The annotation 208 comprises the name given the entry by the user. The annotation name 210 comprises the actual file name attributed to the entry by the diary 100 as for example may be stored in a file allocation table (FAT). The file type 212 designates the type of file or files associated with a given annotation. As shown, each annotation may include one or more entries and types of entry, such as separate audio and image files. For example, the annotation dated Apr. 2, 2005 having a time of 1:20 P.M., contains both an image entry (IMAGE1.BMP) and an audio entry (MP31.MP3).

The other metadata field 212 may include metadata derived from the diary annotation 208 as well as other non-derived metadata as discussed above. For the example dated May 7, 2005 having a time of 3:30 P.M., the MP33.3 file from field 210 may contain key phrases such as, “my”, “graduation” and “next week” that would allow the diary 100 though operation of the CUMG module 34 to derive metadata for entry into other metadata field 214 including ABOUT=ANNE GRADUATION.

The CUMG module 34 may also derive other context from an input, such as an emotional context of the input, such as video or voice segments. For example, from a voice segment, the CUMG module 34 may determine whether the speaker is emotional, aroused, exited, etc. (e.g., happy, sad, mad, in love), specifically, and/or more generally, a high/low emotional context of input, and associate context identifying metadata to the voice segment (also those in a video input, etc.).

The other metadata field 214 may also contain a PRIVACY entry which may control which user, in a multiple user embodiment, may access a given entry. For example, the annotation dated Apr. 1, 2005 having a time of 9:55 A.M., has an associated metadata of PRIVACY=0. This metadata which was entered by USER ID=2 (Dad), may be retrieved by any user of the diary 100, while the annotation dated Apr. 1, 2005 having a time of 8:02 A.M., has an associated metadata of PRIVACY=1 and therefore may only be retrieved by the user that made the entry (USER ID=1, Anne). The privacy metadata for a given annotation may be set by the user at the time of annotation entry as supported by the user interface. Another point of note is that a given annotation may have multiple metadata for a given metadata type. For example, the annotation dated Apr. 1, 2005 having a time of 9:55 A.M., contains a metadata type of SUBJECT having values of TRIP and JEFF MEMORIAL, each of which may be utilized for annotation retrieval as discussed below.

To make a video annotation, various initialization operations are contemplated including the general initialization operations discussed above as well as other initialization operations that particularly indicate to the diary 100 that a video annotation is intended by the user. These particular initialization operations may include, for example, a video annotation button and a voiced keyword trigger (“look here”), etc.

When the user initiates a video annotation in the manner described above or by other means, the diary 100 preferably provides some form of feedback to indicate that video annotation has been initiated. This feedback may include, for example: an LED, the system providing a verbal feedback cue (e.g., “Show me . . . ”), and/or providing an emotive response in the case of a robotic embodiment (e.g., the device blinking or nodding).

To make a video diary annotation, the diary 100 may include the video/image capture module 24 shown in FIG. 1 for processing video inputs to the diary 100. A video diary annotation made by a user may be accompanied by other annotation types, such as a voice diary annotation. However, a video diary annotation can be made without including an associated voice diary annotation.

The video inputs processed by the video/image capture module 24, are provided as input to the CUMG module 34. The CUMG module 34 derives metadata from the processed video inputs similar as discussed above with regard to text voice input, and by examining the image for identifiable objects within the image. The metadata derived from the processed video inputs are stored and associated with the processed video inputs in storage module 36. For example, the annotation dated Apr. 1, 2005 having a time of 8:02 A.M., contains both a video entry (VID1.mov) and associated metadata, such as SUBJECT=MARK and LOCATION=HOME.

Diary annotations may be retrieved by user initiated retrieval or by the diary 100 independent of a user retrieval request. In the case of a user initiating annotation retrieval of a diary annotation (e.g., video and/or voice), the user may make an explicit retrieval request to the diary 100 to retrieve a previous diary annotation, such as a previously recorded video diary annotation and/or a previously recorded audio diary annotation. A user request to retrieve a diary annotation (e.g., video and/or voice) in one embodiment may be supplied as a vocalized request to the voice recognition interface 22. In this or other embodiments, the user may request to retrieve a diary annotation by utilizing other entry systems such as by a keyboard, a mouse, a stylus, etc.

By way of example, the user may vocalize a request to retrieve a diary annotation such as, “What did I say about Mark yesterday”. The user request is processed by the voice recognition interface 22 and the processed output is provided to the CUMG module 34 to generate metadata from the processed voice input. The generated metadata (e.g., terms such as “Mark” and “yesterday”) is forwarded to the CRM module 32 which uses the metadata to find related metadata in the storage module 36. As used herein, related metadata from the storage module 36 may be the same (e.g., Mark=Mark) or similar to (Mark Mark's) the metadata generated during the retrieval request. The CRM module 32 also may use combinations of metadata to retrieve a most relevant saved diary annotation. For example, the diary 100 may have numerous annotations with an associated metadata of Mark. However, only some subset of these annotations may have a further metadata of yesterday's date. Accordingly, only those subset of annotations that have both Mark and yesterdays date as metadata would be retrieved by the CRM module 32 in response to the above request.

Annotations may also be retrieved with regard to the context metadata, such as a request for annotations in which emotional context was high. This might be desirable since a particular user may utilize the diary for expressive writing to cope with emotional experiences. In either event, a user might want to review annotations that relate to a particular context. For example, a user may wish to retrieve annotations when they were sad. The context metadata, similarly to other metadata, may aid in this type of annotation retrieval request.

Upon locating the appropriate diary annotation(s) from the storage module 36, the annotation(s) is retrieved and forwarded to the dialogue management module 40. The dialogue management module 40 analyzes the retrieved diary annotation(s) to determine the type of each annotation (e.g., is it a video annotation, voice annotation, etc.) and directs the retrieved diary annotation(s) to appropriate rendering devices. For example, a retrieved voice annotation may be directed to the speech syntheses module 38 for speech rendering to the user. Naturally, in a case wherein a retrieved annotation is a recorded voice annotation (e.g., a wav file), the speech synthesis module 38 may be simply a speaker for audibly reproducing the retrieved voice annotation. Other retrieved entries may be directed to the RNVC module 42 for non-verbal rendering, such as a display of text, video, etc. to the user. The dialogue management module 40 may also use context metadata to direct the speech synthesis module 38 to render a retrieved annotation with corresponding context. For example, a retrieved high emotion context annotation may be rendered with matching context.

In the case of the diary 100 initiating annotation retrieval, the CRM module 32 analyzes metadata output from the CUMG module 34 that is derived from a current annotation for storage (as discussed above), for suggesting to the user the opportunity to view previously stored annotations that may have some degree of correlation to the current annotation. In this way, the diary 100 independent of a user request for annotation retrieval, may offer the user the opportunity to retrieve, such as view and/or listen to similar (e.g., similar subject, objects, time, etc.) stored annotations. The diary 100 may utilize matching techniques such a metadata keyword matching or visual feature similarity techniques to identify similar previously stored annotations.

For example, when the diary 100 is receiving the Apr. 2, 2005 annotation at 1:40 P.M., the CRM module 32 may receive the associated metadata shown in field 214. The CRM module may query the storage module 36 to identify other annotations that have the same or similar associated metadata. In this case, the diary 100, though use of the user interface, may provide Anne with the opportunity to review the annotation entered on Apr. 1, 2005 at 8:02 A.M. due to the similarity between one or more metadata of the current and stored annotation (e.g., SUBJECT=MARK, ORIG=ANNE). Additional stored annotations, such as the annotation entered on Apr. 2, 2005 at 1:40 P.M., may also be suggested to Anne for review.

The diary 100 may also utilize matching techniques such a context metadata matching/contrasting to identify previously stored annotations. The context of an annotation may include a detected mood of a user, an environment of the annotation entry/retrieval, as well as other surrounding conditions of an annotation entry/retrieval.

For example, systems are known that can detect the mood of user. U.S. Pat. No. 6,931,147, issued Aug. 16, 2005 and entitled “Mood Based Virtual Photo Album”, to Antonio Colmenarez et al., which is incorporated herein by reference as if set out in entirety, discloses methods for determining the mood of a user by image pattern recognition. This determination is made by comparing the facial expression with a plurality of previously stored images of facial expressions having an associated emotional identifier that indicates a mood of each of the plurality of previously stored images. U.S. Pat. No. 6,795,808, issued Sep. 21, 2004 and entitled “User Interface/Entertainment Device That Simulates Personal Interaction And Charges External Database With Relevant Data”, to Hugo Strubbe et al., which is incorporated herein by reference as if set out in entirety, discloses methods for determining the mood of a user by analyzing audio and image signals of a user.

These and other systems may be utilized in accordance with the present system. For example, when the diary 100 is receiving the Apr. 2, 2005 annotation at 1:40 P.M., the CRM module 32 may receive context metadata, such as by detecting a lonely context of the user during annotation entry. The CRM module may query the storage module 36 to identify other annotations that have the same, similar or contrasting associated context metadata. In this case, the diary 100, though use of the user interface, may provide Anne with the opportunity to review the annotation entered on Apr. 1, 2005 at 8:02 A.M. due to a similarity or contrast between context metadata of the current and stored annotation (e.g., contrasting metadata, lonely contrasted with in love). In this way, matching or contrasting annotations may be retrieved.

The embodiments of the invention described above are intended for purposes of illustration only, and should not be construed as limiting the appended claims to any particular embodiment or group of embodiments. Numerous alternative embodiments may be devised by those having ordinary skill in the art without departing from the spirit and scope of the following claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

1. A method for enabling a user to make diary annotations to an electronic diary, the method comprising the acts of:
creating a diary annotation,
deriving metadata from the annotation, and
storing the diary annotation and the derived metadata in the electronic diary.

2. The method of claim 1, wherein the act of creating a diary annotation, further comprises:
receiving an auditory input from a user as the diary annotation, and
processing the received auditory input to recognize speech terms.

3. The method of claim 2, wherein the derived metadata is derived from the recognized speech terms.

4. The method of claim 2, further comprising the act of the user initiating the creation of the voiced diary annotation through one of a dedicated button and a voiced keyword trigger.

5. The method of claim 4, further comprising the act of providing user feedback responsive to the user initiating the creation of the voiced diary annotation.

6. The method of claim 1, wherein the act of creating the diary annotation, further comprises the act of:
receiving a video input from the user, and
processing the received video input to identify objects depicted in the video input.

7. The method of claim 6, wherein the derived metadata is derived from the identified objects.

8. The method of claim 6, further comprising the act of the user initiating a desire to create the video diary annotation though one of a dedicated button and a voiced keyword trigger.

9. The method of claim 8, further comprising the act of providing user feedback responsive to the user initiating the creation of the video diary annotation.

10. The method of claim 1, further comprising the act of storing associated non-derived metadata in the electronic diary.

11. The method of claim 10, wherein the non-derived metadata comprises at least one of a date of annotation, a time of annotation entry, and a user identifier.

12. The method of claim 1, further comprising the act of rendering a previously stored diary annotation to the user.

13. The method of claim 12, wherein the previously stored diary annotation is rendered independent of a user request.

14. The method of claim 13, further comprising the act of determining a correlation between metadata of the created annotation and the previously stored annotation, wherein the previously stored diary annotation is selected based on the correlation.

15. An electronic diary, comprising:
means for receiving a diary annotation,
means for deriving metadata from the diary annotation, and
means for storing the diary annotation and the derived metadata in a data repository.

16. The electronic diary of claim 15, further comprising means for providing user feedback responsive to the means for receiving the diary annotation.

17. The electronic diary of claim 17, further comprising means for rendering a previously stored diary annotation.

18. The electronic diary of claim 17, wherein the previously stored video diary annotation is rendered based on a determined correlation with the received diary annotation.

19. A computer-readable medium encoded with processing instructions for use with an electronic diary, the processing instructions comprising:
a program portion for controlling receipt of an electronic annotation,
a program portion for deriving metadata from the electronic annotation, and
a program portion for controlling storing the electronic annotation and the derived metadata in the electronic diary.

20. The computer-readable medium of claim 19, the processing instructions comprising:
a program portion for determining a correlation between a previously stored diary annotation and the received diary annotation; and
a program portion for controlling rendering the previously stored diary annotation responsive to the correlation.
